(19) United States
(12) Patent Application Publication
(10) Pub. No.: US 2025/0087932 A1
(43) Pub. Date: Mar. 13, 2025

(54) CONNECTION ADAPTER FOR MECHANICALLY CONNECTING CORRESPONDING ELECTRICAL PLUG-IN CONNECTORS

(71) Applicant: Weidmüller Interface GmbH & Co. KG, Detmold (DE)

(72) Inventor: Tobias LANGER, Lemgo (DE)

(21) Appl. No.: 18/882,686

(22) Filed: Sep. 11, 2024

(30) Foreign Application Priority Data
Sep. 12, 2023 (DE) 102023124536.8

(51) Int. Cl. H01R 13/518; H01R 13/514

(52) U.S. Cl. CPC H01R 13/518; H01R 13/514

(57) ABSTRACT

A connection adapter for mechanically connecting corresponding electrical plug-in connectors, which preferably each have electrical plug-in connector disks mounted in series, includes a first adapter disk part, for series mounting of at least one electrical plug-in connector disk of the first plug-in connector in and/or against a series-mounting direction, and a second adapter disk part, for series mounting of at least one electrical plug-in connector disk of the second plug-in connector in and/or against the series-mounting direction. The first and second adapter disk parts can be releasably latched together. The connection adapter, which is constructed to be self-locking, includes a latching mechanism for latching the adapter disk parts together so that the latching of the adapter disk parts is produced directly when the two plug-in connectors are pushed together in or against a pushing direction.

### BACKGROUND

The invention relates to a connection adapter for mechanically connecting corresponding electrical plug-in connectors, which preferably each have series-mounted electrical plug-in connector disks, and a plug-in arrangement including the two plug-in connectors and such a connection adapter.

In electrical applications, for example for production technology or control cabinet construction, there is a need to be able to connect corresponding plug-in connectors, in particular consisting of plug-in connector disks series mounted in rows to each other in a simple, mechanically secure releasable manner.

The problem of the present invention is therefore to create a low-cost connection adapter that is easy and quick to assemble. Specifically, for the releasable mechanical connection of plug-in connectors from plug-in connector disks which are preferably mounted in series.

### SUMMARY OF THE DISCLOSURE

Accordingly, it is an object of the present disclosure to provide a connection adapter for mechanically connecting corresponding plug-in connectors, which preferably each have series-mounted electrical plug-in connector disks. The connection adapter has a first adapter disk part for series-mounting at least one electrical plug-in connector disk of a first plug-in connector in and/or against a series-mounting direction. Furthermore, it has a second adapter disk part for series-mounting at least one electrical plug-in connector disk of a second (mating) plug-in connector in and/or against the series-mounting direction. The adapter disk parts can be releasably latched together, wherein the connection adapter comprises a latching mechanism for latching the two adapter disk parts for the two plug-in connectors together. This latching mechanism is configured in a self-latching manner such that the latching of the adapter disk parts is produced directly when the two plug-in connectors are pushed together in or against a pushing direction.

The two plug-in connectors of the plug-in arrangement are thus simply latched together by pushing the second adapter disk part onto the first adapter disk part.

The plug-in connector disks preferably have corresponding plug-in faces which can be plugged together and which have corresponding plug-in contacts. When the adapter disk parts are plugged together, the plug-in faces of the two plug-in connector disks are preferably also plugged together and the plug-in contacts are connected to each other. Furthermore, the plug-in connector disks of the two plug connectors preferably each have at least one or more connection contacts connected to the respective plug contact or contacts for connecting a conductor or a connection of an electrical device such as a printed circuit board.

The low-cost connection adapter disk parts for mechanical connection of the plug-in connectors made up of series-mounted plug-in connector disks are advantageously easy and quick to assemble. The term “disk” is defined broadly. The disks do not have to be flat but can be configured relatively wide and not in the series-mounting direction.

In one embodiment, the adapter disk parts each include a housing part which surrounds an interior space part. The latching mechanism comprises a latching hook mechanism which extends at least partially in both interior space parts when the adapter is in a latching state in which the first adapter disk part is latched onto the second adapter disk part. The latching mechanism is envisaged for securely connecting the adapter disk parts and thus the two plug-in connectors.

For this purpose, the latching mechanism preferably comprises a mating latch, which is arranged on or in the second adapter disk part, and a latching hook, which is arranged on the latching hook mechanism and which interacts in a latching manner with the mating latch in the latching state.

In another embodiment, the second housing part forms the mating latch. Here, it is particularly preferred that the latching hook mechanism be automatically adjusted from a releasing position, in which the latching hook does not interact with the mating latch, to a latching position in which the latching hook interacts with the mating latch in a latching manner. Through automatic adjustment of the latching hook mechanism from the releasing position to the latching position, the latching mechanism securely and enduringly latches the adapter disk parts together, including in demanding environments such as with strong vibrational stress.

In yet another embodiment, the first adapter disk part includes a rotary bearing which forms an axle of rotation, wherein the latching hook mechanism is rotatably borne on the rotary bearing in a reversible manner about the axle of rotation in a direction of rotation. The latching hook mechanism can therefore be reversibly adjusted from the latching position to the releasing position by rotation about the axle of rotation.

Preferably, the first adapter disk part includes a guide which engages in a slotted link of the latching hook mechanism to guide the latching hook mechanism along the slotted link when rotating about the axle of rotation. The shape of the slotted link also makes it possible for the latching hook mechanism to be rotated back from the releasing position to the latching position.

The slotted link preferably includes a releasing end and a latching end, wherein the guide is arranged at the releasing end when the latching hook mechanism is in the releasing position and at the latching end when the latching hook mechanism is in the latching position.

The latching hook mechanism preferably goes fully through the first interior space part of the first adapter disk part in a longitudinal direction transverse to the series-mounting direction.

Preferably, the latching hook mechanism further includes an outside accessible actuator for manually actuating the latching hook mechanism. The actuator protrudes out of the first housing part and is manually actuated, for example with a finger or a screwdriver.

It is further an object of the present disclosure to provide a plug-in arrangement with two plug-in connectors and with a connection adapter as described above. At least one electrical plug-in connector disk of a first plug-in connector is series mounted to a first and a second adapter disk part of the connection adapter of the first plug-in connector in or against a series-mounting direction. At least one electrical plug-in connector disk of the other plug-in connector is series mounted to the other adapter disk part of the connection adapter in or against a series-mounting direction.

The electrical plug-in connector disks of the first and second plug-in connectors or the plug-in connectors formed from the electrical plug-in connector disks of the first and second plug-in connectors can be latched together in a simple and quick manner via the connection adapter. Separation is also simple and quick by actuating the actuator.

### BRIEF DESCRIPTION OF THE DRAWINGS

The invention will be described below with the aid of figures. The figures are merely by way of example and do not restrict the invention to the depicted exemplary embodiment. In the drawings:

FIGS. 1a and 1b are side and perspective views, respectively, of a connection adapter in a latching state;

FIG. 1c is a side view of the connection adapter of FIG. 1a with a second adapter disk part released from a first adapter disk part;

FIGS. 1d-1e are side and perspective views of the connection adapter of FIG. 1a in a separation state in which the second adapter disk part is separated from the first adapter disk part; and

FIGS. 2a and 2b are perspective views of a plug-in connectors and connector disks with the connection adapter of FIG. 1.

### DETAILED DESCRIPTION

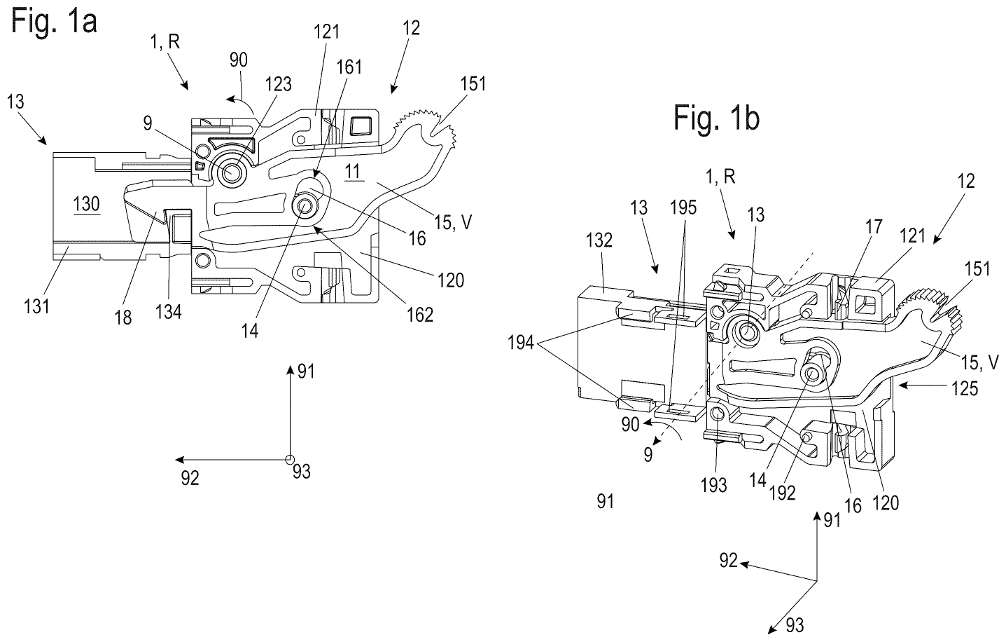

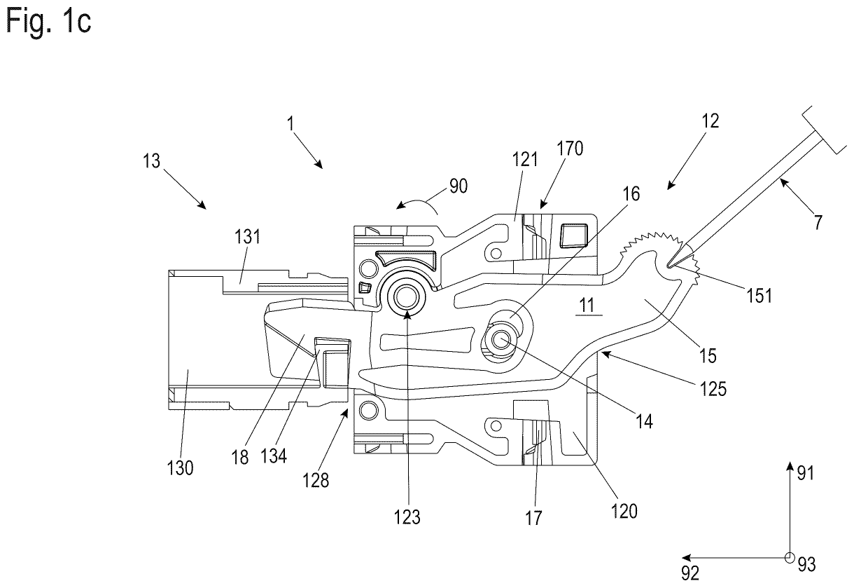

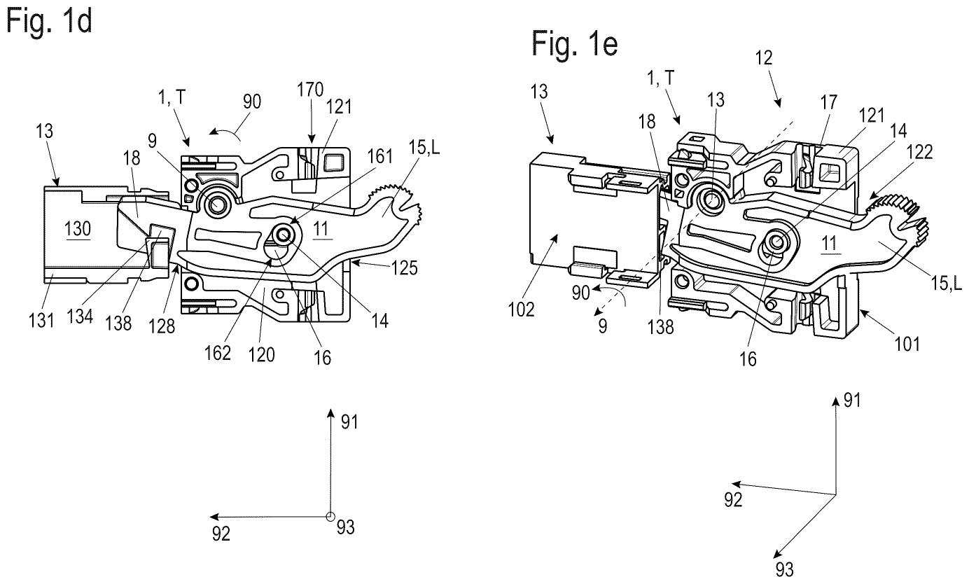

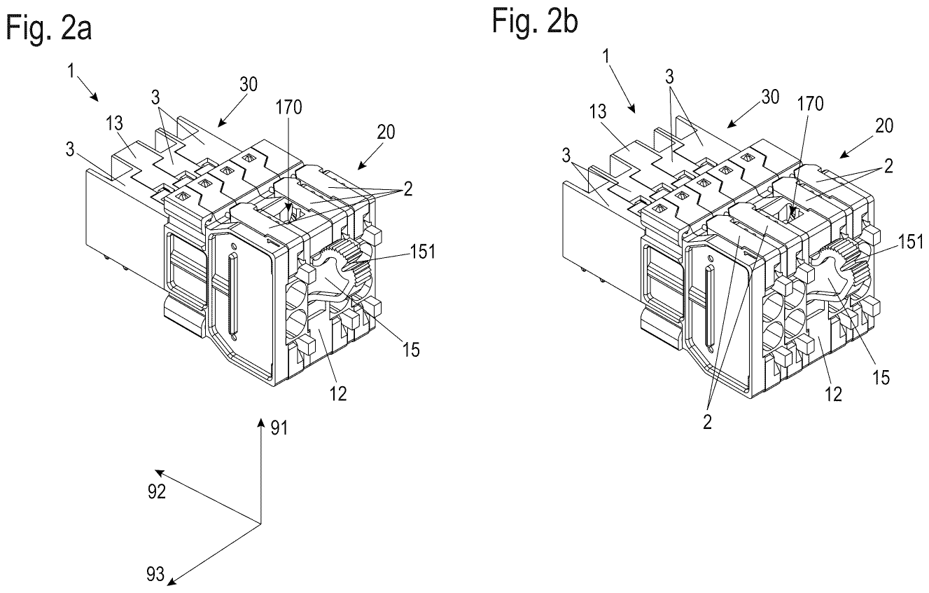

FIG. 1 shows a connection adapter 1 according to the invention. The connection adapter 1 is envisaged for the mechanical connection of two corresponding electrical plug-in connectors 20, 30, which can in each case have a series of plug-in connector disks 2, 3 (see FIGS. 2a, 2b). The plug-in connector disks 2, 3 of the respective plug-in connectors 20, 30 can thus be plugged together in a series-mounting direction 93.

The two plug-in connector disks 2, 3 of the two plug-in connectors 20, 30 additionally each preferably have corresponding plug-in faces which can be plugged together and which have corresponding plug-in contacts which can be plugged together, as in FIG. 2 (not shown in detail here, e.g. constructed as pin and socket contacts). The two plug-in connectors can be plugged together in a plugging or pushing direction 92, which is aligned perpendicular to the series-mounting direction 93.

The connection adapter 1 has a first adapter disk part 12, which is envisaged for series-mounting at least one or more of the first electrical plug-in connector disks 2 of the first plug-in connector in and/or against a series-mounting direction 93. The connection adapter 1 also has a second adapter disk part 13, which is provided for series-mounting at least one or more of the second plug-in connector disks 3 of the second corresponding plug-in connector in and/or against the series-mounting direction 93.

The adapter disk parts 12, 13 can be releasably latched together by a latching mechanism, which is constructed to be self-latching such that the latching is produced directly and automatically when the plug-in connectors 20, 30 are pushed together in the pushing direction 92.

The connection adapter 1 can be lined up between the plug-in connector disks 2, 3 when first and second plug-in connector disks 2, 3 are series-mounted on both sides of the connection adapter 1 (i.e. in and against the series-mounting direction 93). The connection adapter 1 is disk-shaped for this purpose. Both the first adapter disk part 12 and the second adapter disk part 13 each have two wide sides 102 (see FIG. 1e), which are situated opposite one another and which are connected to each other by narrow sides 101. Alternatively, several connection adapters can be envisaged.

The wide sides 102 extend flat parallel to a plane, which is spanned by a line (not shown) extending in a Z-direction 91 and a line (not shown) extending in a pushing direction 92. The Z-direction 91 and the pushing direction 92 extend transverse to each other and transverse to the series-mounting direction 93.

FIGS. 1a and 1b are side and perspective views, respectively, showing the connection adapter 1 in a latching state R in which the first adapter disk part 12 is latched onto the second adapter disk part 13. FIG. 1c shows the connection adapter 1 when the second adapter disk part 13 is being released from the first adapter disk part 12. FIGS. 1d and 1e are side and perspective views, respectively, showing the connection adapter 1 in a separation state T in which the second adapter disk part 13 is separated from the first adapter disk part 12.

The adapter disk parts 12, 13 show in each case a housing part 121, 131 which surrounds an interior space part 120, 130. The housing parts 121, 131 are manufactured as insulating material housing parts, in particular made of a plastic. In the latching state R, the latching mechanism extends into the interior space parts 120, 130 of both adapter disk parts 12, 13. In the present exemplary embodiment it goes through the first adapter disk part 12 fully and goes through the second adapter disk part 13 at least partially.

The latching mechanism has a latching hook mechanism 11 which is rotatably borne on the rotary bearing 123 in a reversible manner about the axle of rotation 9 in a direction of rotation 90. The rotary bearing 123 is constructed as a web, which is manufactured integrally with the first housing part 121. It extends along the axle of rotation 9, which is aligned in the series-mounting direction 93.

The latching hook mechanism 11 is constructed to be flat and extends parallel to the wide sides 102.

To latch the second adapter disk part 13 onto the first adapter disk part 12, the latching mechanism has a mating latch 134 that is arranged on or in the second adapter disk part 13 and is integrally manufactured with the second housing part 131 of the second adapter disk part 13. The latching mechanism further has a latching hook 18 arranged on the latching hook mechanism 11, which is preferably integrally manufactured with the latching hook mechanism 11. In the latching state R, the latching hook 18 interacts with the mating latch 134 in a latching manner.

For this purpose, the latching hook 18 protrudes out of the first adapter disk part 12 through a first connection aperture 128 which goes through a narrow side 101 of the first housing part 121. When the connection adapter 1 is in the latching state R, the latching hook 18 protrudes into the second adapter disk part 13 through a second connection aperture 138, which goes through a narrow side 101 of the second housing part 131. In the latching state R, the latching hook 18 engages behind the mating latch 134.

By rotating the latching hook mechanism 11 in the direction of rotation 90, the latching hook mechanism 11 can be automatically adjusted from a releasing position L, in which the latching hook 18 does not interact with the mating latch 134, into a latching position V in which the latching hook 18 interacts with the mating latch 134 in a latching manner. When the latching hook mechanism 11 is in the releasing position L, the second adapter disk part 13 can be separated from the first adapter disk part 12, in particular by shifting in the pushing direction 92. The connection adapter 1 is then in the separation state T.

The first adapter disk part 12 has a guide 14 in a slotted link 16 of the latching hook mechanism 11 to automatically latch the latching mechanism. The guide 14 is integrally formed with the first housing part 121 and extends parallel to the axle of rotation 9 in the series-mounting direction 93.

When the latching hook mechanism 11 is rotated about the axle of rotation 9, the slotted link 16 is guided along the guide 14. The guide 14 is arranged at a releasing end 161 of the slotted link 16 when the latching hook mechanism 11 is in the releasing position L and is arranged at a latching end 162 of the slotted link 16 when the latching hook mechanism 11 is in the latching position V. The slotted link 16 is configured such that the latching hook mechanism 11 automatically rotates into the latching position V starting from the releasing position L when the two adapter disk parts 12, 13 are pushed into one another in the pushing direction 92.

To separate the adapter disk parts 12, 13 from one another, the latching hook mechanism 11 includes an actuator 15, which is envisaged for manually actuating the latching hook mechanism 11. It is integrally manufactured with the latching hook mechanism 11 and is accessible from the outside through an actuation aperture 125, which is arranged opposite the first connection aperture 128 and goes through a narrow side 101.

A slot-shaped actuation recess 151 is provided on the actuator 15 for option actuation by a finger or with a screwdriver 7.

On the further narrow sides 101 of the first adapter disk part 12, third and fourth connection apertures 170 are provided with snap-on connections 17, at which the adjacent plug-in connector disks 2, the two plug-in connectors 20, can be serially mounted.

FIGS. 2a and 2b show a plug-in arrangement plugged together from two corresponding plug-in connectors with the connection adapter of FIG. 1. The plug-in connectors 20, 30 differ here only in the number of electrical plug-in connector disks 2, 3 series mounted on the connection adapter 1.

In the embodiment of FIG. 2a, one plug-in connector disk 2 of the first plug-in connector 20 and one plug-in connector disk 3 of the second plug-in connector 30 are series mounted in the series-mounting direction 93. In each case, two plug-in connector disks 2 of the first plug-in connector 20 and two plug-in connector disks 3 of the second plug-in connector 30 are connected against the series-mounting direction 93 to the connection adapter 1

In the embodiment of FIG. 2b, two plug-in connector disks 2 of the first plug-in connector 20 and two plug-in connector disks 3 of the second plug-in connector 30 are series mounted in and against the series-mounting direction 93 to the connection adapter 1.

To series-mount the plug-in connector disks 2, 3 onto each other and to the respective adapter disk part 12, 13, the adapter disk parts 12, 13 can each have sliding, snap-on and latching hook mechanisms 192, 193, 194, 195 corresponding to the series-mountable plug-in connector disks 2, 3 of their plug-in connector.

By separating the second adapter disk part 13 from the first adapter disk part 12 (i.e. by actuating the actuator 15) so that the latching hook mechanism 11 rotates against the direction of rotation 90, the connection terminal arrangement can be separated into two plug-in connectors 20, 30, wherein the first of the two plug-in connectors 20 then comprise the plug-in connector disks 2 of the first plug-in connector and the first adapter disk part 12, and the second of the two plug-in connectors 30 comprise the plug-in connector disks 3 of the second plug-in connector and the second adapter disk part 13.

The plug-in connectors 20, 30 are thus able to be simply latched together by pushing the second adapter disk part 13 against the pushing direction 92 onto the first adapter disk part 12.

The latching hook 18 has a ramp (not identified) for this, which is guided along the mating latch 134 when the latching hook 18 is pushed into the second interior space part 130 of the second adapter disk part 13. In doing so, the latching hook mechanism 11 rotates against the direction of rotation 90 from the latching position V into the releasing position L. As soon as the latching hook 18 has passed the mating latch 134, the latching hook mechanism 11 is automatically rotated back in the direction of rotation 90 such that the lower edge of the latching hook mechanism 11 presses against the narrow side of the adapter disk part 13 underneath the second connection aperture 138. As a result, the latching hook 18 is rotated in the direction of rotation 90 and then engages behind the mating latch 134 such that the adapter disk parts 12, 13 latch together in the latching position V. The plug-in connectors 20, 30 are then latched together again from two plug-in connectors to form a plugging arrangement.

What is claimed is:

1. A connection adapter for mechanically connecting corresponding electrical plug-in connectors having electrical plug-in connector disks mounted in series, comprising a first adapter disk part for series mounting at least one electrical plug-in connector disk of a first plug-in connector in or against a series-mounting direction, a second adapter disk part for series mounting at least one electrical plug-in connector disk of a second plug-in connector in or against the series-mounting direction, the first and second adapter disk parts being releasably latched, wherein the connection adapter further comprises a self-locking latching mechanism for directly latching the adapter disk parts together when the two plug-in connectors are pushed together in or against a pushing direction.

2. The connection adapter according to claim 1, wherein the plug-in connector disks of the two plug-in connectors have corresponding plug-in faces configured to be plugged together and corresponding plug contacts configured to be plugged together.

3. The connection adapter according to claim 1, wherein the plug-in connector disks of the two plug-in connectors have at least one connection contact for connecting a conductor or a printed circuit board.

4. The connection adapter according to claim 1, wherein the first adapter disk part comprises a first housing part and the second adapter disk part comprises a second housing part, the first and second housing parts each surrounding a first and second interior space part, respectively, the latching mechanism comprising a latching hook mechanism arranged to extend at least partially in both interior space parts when the connection adapter is in a latching state in which the first adapter disk part is latched onto the second adapter disk part.

5. The connection adapter according to claim 4, wherein the latching mechanism comprises a mating latch arranged on or in the second adapter disk part and a latching hook arranged on the latching hook mechanism configured to interact in a latching manner with the mating latch when the connection adapter is in the latching state.

6. The connection adapter according to claim 5, wherein the second housing part includes the mating latch, the latching hook mechanism being automatically adjusted from a releasing position in which the latching hook does not latch with the mating latch to a latching position in which the latching hook latches with the mating latch.

7. The connection adapter according to claim 1, wherein the first adapter disk part comprises a rotary bearing forming an axle of rotation, the latching hook mechanism being rotatably borne on the rotary bearing in a reversible manner about the axle of rotation in a direction of rotation.

8. The connection adapter according to claim 7, wherein the first adapter disk part comprises a guide in a slotted link of the latching hook mechanism to guide the latching hook mechanism along the slotted link when rotating about the axle of rotation.

9. The connecting adapter according to claim 8, wherein the slotted link comprises a releasing end and a latching end, the guide being arranged at the releasing end when the latching hook mechanism is in the releasing position and at the latching end when an actuator is in the latching position.

10. The connection adapter according to claim 4, wherein the latching hook mechanism extends entirely through the first interior space part of the first adapter disk part.

11. The connection adapter according to claim 1, wherein the latching hook mechanism comprises an actuator for manually actuating the latching hook mechanism, the actuator being accessible from an outer portion of the adapter.

12. A plug-in arrangement with two plug-in connectors and with a connection adapter according to claim 1, wherein the at least one electrical plug-in connector disk of the first plug-in connector is series mounted to the first adapter disk parts of the connection adapter in or against a series-mounting direction, and the at least one electrical plug-in connector disk of the second plug-in connector is series mounted to the second adapter disk part of the connection adapter in or against a series-mounting direction.
